(19) United States
(12) Patent Application Publication
(10) Pub. No.: US 2013/0004631 A1
(43) Pub. Date: Jan. 3, 2013

(54) FOOD PRODUCT STABILIZER SYSTEM

(76) Inventors: RC Obert, Mableton, GA (US); Chris Kline, Marietta, GA (US); Simon Shamoun, Acworth, GA (US)

(21) Appl. No.: 13/606,182

(22) Filed: Sep. 7, 2012

Related U.S. Application Data
(62) Division of application No. 12/332,586, filed on Dec. 11, 2008.
(60) Provisional application No. 61/107,835, filed on Oct. 23, 2008.

(51) Int. Cl. A23P 1/08; A23L 1/01; A23L 1/00; A23P 1/10

(52) U.S. Cl. 426/281; 426/512; 426/297; 426/335; 426/302; 426/289; 426/293; 426/296; 426/531

(57) ABSTRACT

A method for processing a food product includes in sequence providing ingredients to the food product; reducing a temperature of a surface of the food product for providing a crust at the surface to retain the ingredients in the food product and adapt the food product for retaining deformation to a select shape; and pressing the food product in to the select shape, wherein the shape of the food product and the ingredients in the food product are retained for subsequent processing.

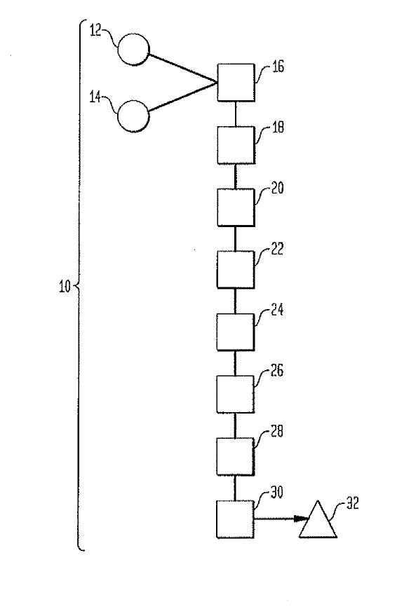

### BACKGROUND OF THE INVENTION

The present invention relates to stabilizing food products for treatment and processing.

Known processes for food products include pressing the food product, such as by mechanical presses, and various forms of treatment to physically arrange the product in a predetermined manner for subsequent processing. In particular, where the food product is injected with for example ingredients such as marinates or other treatment solutions, it is important that the ingredients are retained in the food product during subsequent processing, even during pressing the food product. Unfortunately, this is not carried out with known systems. In other words, it is desirable not to permit a “purge out” of any marinates or solutions that have been injected into the food product. In addition, since the food product is sized for a particular end use, it is important that a resulting yield is maintained of the food product so that subsequent processing is efficient and cost effective, i.e. the product remains in the same physical form (doesn't “rebound”) through the processing line without loss of any of the product, compromise of product dimensions, or loss of any solutions or ingredients incorporated therein. Known systems do not provide for these processing requirements.

### BRIEF DESCRIPTION OF THE DRAWING

For a more complete understanding of embodiments of the present invention, reference may be had to the following drawing taking in conjunction with the description of the invention, of which:

The FIGURE shows a flow chart of an embodiment of the system process of the present invention for use upon food products.

### DESCRIPTION OF THE INVENTION

Referring to the FIGURE, a stabilizing system embodiment of the present invention is shown generally at 10. A food product is stabilized for processing by system and method embodiments of the invention. The system 10 includes a method for processing a myriad of different food products such as for example chicken breast patties 12 and other meat or fish patties 14, collectively referred to herein as food products. The food products 12, 14 can be for example boneless chicken breasts of marinated pressed breast meat for use in retail sandwiches. For the sake of brevity and by way of example only, reference will be with respect to a boneless chicken breast food product 12.

The food product 12 or product is cut and measured having particular dimensions for being introduced into the system 10 for batch or continuous processing. The system may also be used with products 12 that are of the IQF-type, i.e. individually quick frozen type.

The system 10 includes an injection station 16 wherein the product 12 is infused such as by injection with marinates, perhaps antibiotics, and/or other fluids, ingredients or compositions to maintain or improve the taste, smell, freshness and mouth feel of the food product 12.

The product 12 then proceeds to a tumbling step 18 wherein the product may be vacuum tumbled and chilled in a rotating tumbler system.

The product 12 is then transferred to a stabilizing step 20 of the invention. The stabilizing step 20 processes the product 12 so that it will not “rebound”, i.e. will not return to its original, unacceptable shape and/or thickness. In the stabilizing step 20, the product 12 is chilled with cooling or freezing technology, such as for example impingement freezing technology, after at least one of the injection step 16 and the tumbling step 18. The stabilizing step employing the cryogen chilling technology, such as cryogen impingement chilling, insures that the food product 12 maintains its shape during subsequent processing steps of this system 10 and retains any marinates, ingredients or other fluids earlier injected into the product 12 prior to the stabilizing step 20. The stabilizing step increases the surface firmness of the product 12 and substantially reduces if not eliminates product rebounding to its original shape during subsequent processing.

Impingement freezer technology is one manner of stabilizing the product 12 during the stabilizing step 20, although other chilling technologies may be employed on the product 12. The stabilizing step 20 of cooling or freezing may provide a crust, such as for example a 1/16″ crust, to the product 12 surface or surface area. The crust retains any fluids such as marinates which have been injected earlier into the product 12 so that said fluids remain in the product during the subsequent pressing step 22. The crust also helps to substantially reduce if not eliminate the product 12 rebounding to its original shape during subsequent processing. Thus, the stabilizing step 20 permits the product 12 to retain the deformed shape selected for the product after the pressing step.

Accordingly, use of the stabilizing step 20 after the product 12 has been subjected to the injection step 16 and/or the tumbling step 18, but before the product 12 is subject to the pressing step 22, prevents product rebound and loss of that which was previously injected into the product 12.

During the pressing step 22, the product 12 is pressed to selected dimensions for a subsequent batter and breading step 24. The previous stabilizing step 20 prevents the product 12 from losing that which was previously injected into the product and insures that the product retains its shape after being pressed during the step 22. The batter and breading step 24 provides for example a pre-dust, batter and bread coating process prior to a heating step for the product 12.

Thereafter the product is cooked, in a heating step 26 such as by frying, by heat from a heat assembly.

The product 12 is then subjected to a freezing step 28, after which the product 12 is packaged in a packaging step 30 for subsequent distribution 32.

All the while subsequent to the stabilizing step 20, the product has been able to retain its shape since the pressing step 22 and to retain any compositions, fluids or marinates injected therein.

The use of the system 10 and process incorporated therein, delivers improved product 12 quality and operational savings to plant processors by reducing re-work of the food product 12 (no product rebound or loss of product ingredients), increased yield benefits, along with increased flexibility and throughput.

An impingement freezer or an immersion freezer may be used for the stabilizing step 20. Impingement freezing includes applying cryogenic spray or a fluid stream to a food product to freeze all or a portion of the product 12. Immersion freezing includes immersing the product 12 into a cryogen fluid for freezing all or a portion of the product 12. The cryogenic fluid used for impingement freezing may be either nitrogen or carbon dioxide; while nitrogen is used in immersion freezing. The impingement freezer technology provides for more efficient use of the cryogen, such as for example nitrogen, as a medium to crust a surface of the food product 12. Impingement and immersion freezer technology and systems are available from Linde LLC of New Jersey USA.

The steps discussed herein can occur in any sequence although the stabilizing step (cooling or freezing) 20 occurs before the pressing step 22.

An embodiment of the invention also includes a product of the process of the stabilizing system 10 of the invention.

It will be understood that the embodiments described herein are merely exemplary and that a person skilled in the art may make many variations and modifications without departing from the spirit and scope of the invention. All such variations and modifications are intended to be included within the scope of the invention as described and claimed herein. It should be understood that the embodiments described herein are not only in the alternative, but may be combined.

What is claimed is:

1. A method for processing a food product, comprising in sequence:
providing ingredients to the food product;
reducing a temperature of a surface of the food product for providing a crust at the surface to retain the ingredients in the food product and adapt the food product for retaining deformation to a select shape; and
pressing the food product in to the select shape, wherein the shape of the food product and the ingredients in the food product are retained for subsequent processing.

2. The method of claim 1, wherein the reducing the temperature comprises providing to the food product a cryogenic fluid selected from nitrogen and carbon dioxide.

3. The method of claim 1, wherein the providing the ingredients comprises injecting the ingredients into the food product.

4. The method of claim 1, wherein the providing the ingredients comprises tumbling the food product in the ingredients for being absorbed into the food product.

5. The method of claim 4, wherein the tumbling is in a vacuum.

6. The method of claim 1, wherein the crust is formed to a depth extending up to one-sixteenth of an inch from the surface of the food product.

7. The method of claim 1, wherein the ingredients comprise compositions selected from marinates, antibiotics, fluids, ingredients and combinations thereof.

8. The method of claim 1, further comprising at least one of:
coating the food product with a composition selected from batter, breading and combinations thereof;
heating the food product;
freezing the food product; and
packaging the food product.

9. The method of claim 8, wherein the heating comprises cooking the food product.

10. The method of claim 8, wherein the heating comprises frying the food product.

11. The method of claim 1, wherein the reducing the temperature comprises impinging a cryogenic substance on the food product.

12. A food product by the method of claim 1.
